(19) United States
(12) Patent Application Publication
(10) Pub. No.: US 2011/0281090 A1
(43) Pub. Date: Nov. 17, 2011

(54) GERMANIUM-CONTAINING HIGH-REFRACTIVE-INDEX THIN FILM AND PRODUCTION METHOD THEREOF

(75) Inventors: Akira Watanabe, Sendai-shi (JP); Tokuji Miyashita, Sendai-shi (JP); Takehiro Nagasawa, Funabashi-shi (JP); Akira Hirooka, Takasaki-shi (JP); Makoto Hirooka, Takasaki-shi (JP); Eiko Hirooka, Takasaki-shi (JP)

(73) Assignees: TOHOKU UNIVERSITY, Sendai-shi, Miyagi (JP); NISSAN CHEMICAL INDUSTRIES, LTD., Tokyo (JP)

(21) Appl. No.: 13/127,180

(22) PCT Filed: Nov. 11, 2009
(86) PCT No.: PCT/JP2009/069213

§ 371 Date: Aug. 1, 2011

(30) Foreign Application Priority Data
Nov. 11, 2008 (JP) 2008-288922
Aug. 28, 2009 (JP) 2009-198541

(51) Int. Cl. C08G 79/00

(52) U.S. Cl. 428/212; 528/9

(57) ABSTRACT

There is provided a high refractive-index coating film and a production method of the high refractive-index coating film. The production method comprises producing a coating film containing a germanium compound containing a Ge—Ge bond as a backbone thereof, and baking the coating film under vacuum or in an inert gas atmosphere. The high refractive-index coating film produced by the method is soluble in a solvent and has a high moldability and film-formation property, and has a high refractive index of 1.8 or more and further 2.3 or more, and is chemically stable.

### TECHNICAL FIELD

The present invention relates to a high refractive-index coating film containing a germanium-containing resin material, and a method for forming the high refractive-index coating film.

### BACKGROUND ART

In various parts of a photoelectronic device and a recording material, polymer materials or polymer thin films are used. These materials or thin films are produced typically using a carbon-based polymer compound having a refractive index of 1.7 or less. In recent years, in response to higher density of photoelectronic devices or larger capacity of recording materials, the application of an optical process having a higher numerical aperture (NA) is regarded as necessary. Therefore, such materials are required to have high refractive indexes.

As an attempt to obtain a polymer material having a higher refractive index, there is performed the development of a polymer compound having an element other than a carbon atom such as a bromine atom and a sulfur atom. However, by this method, there is not yet obtained a polymer compound having a refractive index of more than 1.8.

For the purpose of obtaining a polymer material having a higher refractive index, there is disclosed a high refractive-index resin composition in which fine particles of a metal oxide are dispersed in a polymer. For example, there is disclosed that, in a dispersion in which 50% by weight of zirconia (ZrO₂) fine particles (having a refractive index of 2.1 in a bulk state) are dispersed in an allyl ether isophthalate resin (refractive index: 1.56), a calculatory refractive index of 1.83 is obtained (see Patent Document 1).

Thus, it is known that a high refractive-index polymer material is obtained by dispersing a metal oxide that is well-known as a high refractive-index substance in a resin. However, for obtaining a homogeneous film, the additive amount of inorganic fine particles is limited, so that the level of the obtained refractive index is also limited.

An adding method of inorganic fine particles includes dispersing high refractive-index inorganic fine particles in a micro composite state or a nano composite state in a resin that is synthesized beforehand. For obtaining a homogeneous inorganic fine particles-dispersed resin in which there is no scattering, precise controls with respect to a particle diameter of inorganic fine particles or an organic substituent modifying the surface of inorganic nano particles are regarded as necessary (see Patent Document 2).

On the other hand, as a method for solving such a problem of dispersibility of inorganic fine particles to obtain a high refractive-index polymer material, conceivable is a method for obtaining a polymer compound in which a semimetal element or a metal element having a large atomic number that contributes to obtaining the polymer material having a higher refractive index is incorporated through a chemical bond.

As an example for such a polymer compound, there is disclosed a polysilane having a backbone containing a Si—Si bond (see Patent Document 3). However, the refractive index thereof remains at around 1.75.

As a polymer compound having a backbone structure in which elements having even larger atomic numbers are chemically bonded with each other, a polygermanium in a straight chain structure having a backbone of a Ge—Ge bond is disclosed (see Patent Document 4).

On the other hand, for an optical waveguide as a photoelectronic device of a novel technology and a pattern having a large refractive index difference that constitutes a photonic crystal, demands for a larger refractive index difference have been increased year after year. However, there is never known a technology capable of achieving it with a simpler process.

### RELATED-ART DOCUMENT

### Patent Document

Patent Document 1: Japanese Patent Application Publication No. JP-A-61-291650
Patent Document 2: Japanese Patent Application Publication No. JP-A-2008-44835
Patent Document 3: Japanese Patent Application Publication No. JP-A-2007-77190
Patent Document 4: Japanese Patent Application Publication No. JP-A-5-163354

### DISCLOSURE OF THE INVENTION

### Problem to be Solved by the Invention

The above-described straight chain-type germanium polymer has the problem that, due to a thermal decomposition thereof, a volatile low molecular compound is generated, and the like. Therefore, it has been attempted to obtain a polymer compound containing a Ge—Ge bond and having a branched structure or a cluster structure. However, in recent years, there has been reported a decrease of the refractive index due to the formation of a Ge—O—Ge bond by a photo-cleavage of a Ge—Ge bond in air with respect to a polymer compound containing a Ge—Ge bond and having a cluster structure. That is, even a polymer containing a Ge—Ge bond and having a cluster structure is affected by a photolysis as with a polygermanium containing a Ge—Ge bond as the backbone thereof and having a straight chain structure, so that such a polymer cannot stably maintain a refractive index value thereof.

In order to solve the problems described above, it is an object of the present invention to provide: a high refractive-index thin film capable of being dissolved in a solvent, having high moldability and high film-formation property, having a high refractive index of 1.8 or more and further 2.3 or more at a wavelength of 633 nm, and being chemically stable; and a production method of such a high refractive-index thin film.

It is an another object of the present invention to provide: a pattern-formed coating film composed only of a crystal having a high refractive index at a wavelength of 633 nm of 2.3 or more and 4.0 or less and containing a Ge—Ge bond as a main component; a pattern-formed coating film having an extremely large refractive index difference at a wavelength of 633 nm of 0.5 to 2.0; and a production method of these coating films.

### Means for Solving the Problem

As a result of assiduous research intended to overcome these disadvantages, the inventors of the present invention have found that by baking a coating film containing a germanium compound under vacuum or in an inert gas atmosphere, a chemically stable thin film having a high refractive index can be formed, and completed the present invention.

Specifically, the present invention relates to, according to a first aspect, a production method of a high refractive-index coating film including a process of producing a coating film containing a germanium compound containing a Ge—Ge bond as a backbone thereof and a process of baking the coating film under vacuum or in an inert gas atmosphere.

According to a second aspect, in the production method of a high refractive-index coating film according to the first aspect, the germanium compound is a compound of Formula [1]:

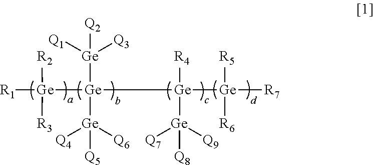

(where R₁, R₂, R₃, R₄, R₅, R₆, and R₇ are independently a group selected from a group consisting of a hydrogen atom, a halogen atom, a hydroxy group, and a substituted or unsubstituted aliphatic hydrocarbon group, alicyclic hydrocarbon group and aromatic hydrocarbon group; Q₁, Q₂, Q₃, Q₄, Q₅, Q₆, Q₇, Q₈, and Q₉ are independently a polymer chain forming a Ge—Ge bond or a group selected from a group consisting of a hydrogen atom, a halogen atom, a hydroxy group, and a substituted or unsubstituted aliphatic hydrocarbon group, alicyclic hydrocarbon group and aromatic hydrocarbon group; and a, b, c, and d are independently an integer including 0 and satisfy a+b+c+≧1).

According to a third aspect, in the production method of a high refractive-index coating film according to the first aspect or the second aspect, the process of baking is performed under vacuum of less than 1 torr (1.33×10² Pa).

According to a fourth aspect, in the production method of a high refractive-index coating film according to any one of claims 1 to 3, the process of baking is performed at a baking temperature of 200° C. to 500° C.

According to a fifth aspect, in the production method of a high refractive-index coating film according to any one of the first aspect to the fourth aspect, the coating film is produced by applying a solution of the germanium compound onto a substrate and drying the solution.

According to a sixth aspect, in the production method of a high refractive-index coating film according to the sixth aspect, the content of the germanium compound in the solution of the germanium compound is 1 to 50% by mass.

According to a seventh aspect, in the production method of a high refractive-index coating film according to any one of the first aspect to the sixth aspect, the high refractive-index coating film has a refractive index at a wavelength of 633 nm of 2.3 or more and 4.0 or less.

According to an eighth aspect, a high refractive-index coating film having a refractive index at a wavelength of 633 nm of 2.3 or more and 4.0 or less is obtained by baking a coating film containing a germanium compound containing a Ge—Ge bond as a backbone thereof under vacuum or in an inert gas atmosphere.

According to a ninth aspect, in the high refractive-index coating film according to the eighth aspect, the germanium compound is a compound of Formula [2]:

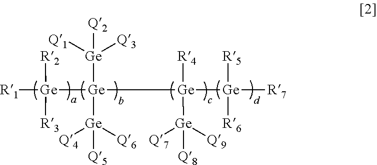

(where R′₁, R′₂, R′₃, R′₄, R′₅, R′₆, and R′₇ are independently a group selected from a hydrogen atom, a halogen atom, a hydroxy group, and a substituted or unsubstituted aliphatic hydrocarbon group and alicyclic hydrocarbon group; Q′₁, Q′₂, Q′₃, Q′₄, Q′₅, Q′₆, Q′₇, Q′₈, and Q′₉ are independently a polymer chain forming a Ge—Ge bond or a group selected from a hydrogen atom, a halogen atom, a hydroxy group, and a substituted or unsubstituted aliphatic hydrocarbon group and alicyclic hydrocarbon group; and

a, b, c, and d are independently an integer including 0 and satisfy a+b+c+≧1).

According to a tenth aspect, a pattern-formed coating film includes a high refractive-index crystal alone that has a refractive index at a wavelength of 633 nm of 2.3 or more and 4.0 or less and that contains a Ge—Ge bond as a main component.

According to an eleventh aspect, a pattern-formed coating film contains, within the same face, a high refractive-index region having a refractive index at a wavelength of 633 nm of 2.3 or more and 4.0 or less and containing a Ge—Ge bond as a main component, and a relatively low refractive-index region having a refractive index at a wavelength of 633 nm of 1.4 or more and 1.8 or less and containing a Ge—O—Ge bond as a main component, in which a refractive index difference between the regions is 0.5 to 2.0.

According to a twelfth aspect, the pattern-formed coating film according to the tenth aspect or the eleventh aspect includes a process of producing a coating film containing a germanium compound of Formula [1] or Formula [2] containing a Ge—Ge bond as a backbone thereof, a process of irradiating the coating film with a radiation for transferring a pattern, and a process of baking the coating film under vacuum or in an inert gas atmosphere.

According to a thirteenth aspect, a production method of the pattern-formed coating film as described in the tenth aspect includes a process of producing a coating film containing a germanium compound of Formula [1] or Formula [2] containing a Ge—Ge bond as a backbone thereof, a process of irradiating the coating film with a radiation for transferring a pattern, and a process of baking the coating film under vacuum or in an inert gas atmosphere at a temperature of 400° C. or more.

According to a fourteenth aspect, a production method of the coating film as described in the eleventh aspect includes a process of producing a coating film containing a germanium compound of Formula [1] or Formula [2] containing a Ge—Ge bond as a backbone thereof, a process of irradiating the coating film with a radiation for transferring a pattern, and a process of baking the coating film under vacuum or in an inert gas atmosphere at a temperature less than 400° C.

### Effects of the Invention

By the production method of a high refractive-index coating film of the present invention, it is possible to produce a high refractive-index coating film having a high refractive index at a wavelength of 633 nm of 1.8 and further 2.3 or more and having extremely high stability relative to photo-oxidizable property.

Accordingly, the high refractive-index coating film produced according to the production method of the present invention can be applied to a material for a high density photoelectronic device, a large capacity recording material, and the like.

Then, the high refractive-index coating film of the present invention can be produced as a coating film having a high refractive index and extremely high stability relative to photo-oxidizable property.

According to the present invention, it is possible to simply and easily produce a pattern-formed coating film composed only of a high refractive-index crystal having a refractive index at a wavelength of 633 nm of 2.3 or more and 4.0 or less and containing a Ge—Ge bond as a main component, that is, a pattern-formed coating film having a refractive index difference of about 2.3 or more and 4.0 or less, taking into consideration a difference of the refractive index from that of air. It is also possible to simply and easily produce a pattern-formed coating film containing, within the same face, a high refractive-index region having the refractive index of 2.3 or more and 4.0 or less and containing a Ge—Ge bond as a main component and a relatively low refractive-index region having the refractive index of 1.4 or more and 1.8 or less and containing a Ge—O—Ge bond as a main component, in which the refractive index difference between the regions is 0.5 to 2.0. A pattern having such an extremely large refractive index difference makes it possible to produce an optical waveguide or a photonic crystal having large light confining capacity.

### BRIEF DESCRIPTION OF THE DRAWINGS

FIG. 1 is a graph showing a thermogravimetric curve for a thin film (PGePh thin film) using a germanium compound according to an embodiment of the present invention in a He atmosphere.

FIG. 2 is a graph showing a thermogravimetric curve for a thin film (PGetBu thin film) using a germanium compound according to an embodiment of the present invention in a He atmosphere.

FIG. 3 is a graph showing a change of an FT-IR spectrum after heating treatment of a thin film (PGePh thin film) using a germanium compound according to an embodiment of the present invention under vacuum.

FIG. 4 is a graph showing a change of an FT-IR spectrum after heating treatment of a thin film (PGetBu thin film) using a germanium compound according to an embodiment of the present invention under vacuum.

FIG. 5 is a schematic view showing an optical thin film physical properties measuring apparatus for measuring an interference spectrum of a thin film using a germanium compound according to an embodiment of the present invention.

FIG. 6 is a graph showing value data with respect to a wavelength distribution of a refractive index and an attenuation coefficient of silicon that is attached to optical thin film designing software FilmWizard manufactured by SCI, Inc. used in the measurement of a refractive index by an interference spectrum method.

FIG. 7 is a graph showing an influence of an ultraviolet ray irradiation on the refractive index of a thin film (PGetBu thin film) using a germanium compound according to an embodiment of the present invention, in which a indicates the thin film before the heating treatment and b indicates the thin film subjected to the heating treatment under vacuum at 300° C. for 30 minutes.

FIG. 8 shows an AFM measurement result (line profile) of a micro pattern-formed coating film (before the heating treatment) produced using a thin film (PGetBu thin film) using a germanium compound according to an embodiment of the present invention.

FIG. 9 shows an AFM measurement result (FIG. 9A: AFM image, FIG. 9B: line profile) of a micro pattern-formed coating film (after the heating treatment) produced using a thin film (PGetBu thin film) using a germanium compound according to an embodiment of the present invention.

FIG. 10 is a graph showing a Raman spectrum measurement result of a micro pattern-formed coating film (after the heating treatment) produced using a thin film (PGetBu thin film) using a germanium compound according to an embodiment of the present invention.

FIG. 11A is a schematic view showing a measuring apparatus for measuring a diffraction image of a micro pattern-formed coating film (after the heating treatment) produced using a thin film (PGetBu thin film) using a germanium compound according to an embodiment of the present invention; FIG. 11B is a diffraction image obtained using the apparatus; and FIG. 11C is Bragg's diffraction equation for calculating a grating period d.

### BEST MODES FOR CARRYING OUT THE INVENTION

Hereinafter, the present invention will be described more in detail.

### [Germanium Compound]

The germanium compound used in the production method of the present invention is a germanium compound containing a Ge—Ge bond as the backbone thereof and is preferably a compound having a branched structure of a Ge—Ge bond. Moreover, the germanium compound is preferably a germanium compound in which each terminal thereof is one type of a hydrogen atom, a halogen atom, a hydroxy group, a substituted or unsubstituted aliphatic hydrocarbon group, a substituted or unsubstituted alicyclic hydrocarbon group, and a substituted or unsubstituted aromatic hydrocarbon group.

Such a germanium compound is preferably a polymer compound having a weight average molecular weight in terms of polystyrene of 500 to 100,000, more preferably a polymer compound having a weight average molecular weight of 600 to 10,000. When the molecular weight is less than 500, a satisfactory refractive index value is difficult to be obtained. When the molecular weight is more than 100,000, the solubility of the polymer compound is lowered.

Preferred examples of the structure of the germanium compound include structures of Formula [1]:

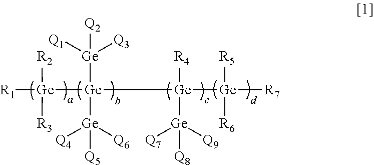

In Formula [1], R₁, R₂, R₃, R₄, R₅, R₆, and R₇ are independently a group selected from a hydrogen atom, a halogen atom, a hydroxy group, a substituted or unsubstituted aliphatic hydrocarbon group, a substituted or unsubstituted alicyclic hydrocarbon group, and a substituted or unsubstituted aromatic hydrocarbon group.

Q₁, Q₂, Q₃, Q₄, Q₅, Q₆, Q₇, Q₈, and Q₉ are independently a polymer chain forming a Ge—Ge bond or a group selected from a hydrogen atom, a halogen atom, a hydroxy group, a substituted or unsubstituted aliphatic hydrocarbon group, an alicyclic hydrocarbon group, and an aromatic hydrocarbon group.

Then, a, b, c, and d are independently an integer including 0 and satisfy a+b+c+d≧1.

Specific examples of the substituted or unsubstituted aliphatic hydrocarbon group, the substituted or unsubstituted alicyclic hydrocarbon group, and the substituted or unsubstituted aromatic hydrocarbon group as R₁ to R₇ and Q₁ to Q₉ include: aliphatic hydrocarbon groups such as a methyl group, an ethyl group, a propyl group, a butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a trifluoromethyl group, a trifluoropropyl group, and a glycidyloxy propyl group; alicyclic hydrocarbon groups such as a cyclopropyl group, a cyclobutyl group, a cyclopentyl group, a cyclohexyl group, a cycloheptyl group, a cyclooctyl group, a cyclononyl group, a cyclodecyl group, a cycloundecyl group, a cyclododecyl group, a cyclotridecyl group, a cyclotetradecyl group, a cyclopentadecyl group, a cyclohexadecyl group, a cycloheptadecyl group, a cyclooctadecyl group, an adamantyl group, a norbornyl group, and an isobornyl group; and aromatic hydrocarbon groups such as a benzyl group, a phenethyl group, a trityl group, a phenyl group, a p-tolyl group, an m-tolyl group, an o-tolyl group, a xylyl group, a mesityl group, a pentafluorophenyl group, a biphenyl group, a naphthyl group, an anthracenyl group, a furyl group, a thienyl group, a pyrrolyl group, an oxazolyl group, an isoxazolyl group, a thiazolyl group, an isothiazolyl group, an imidazolyl group, a pyrazolyl group, a pyridyl group, a pyrimidinyl group, a pyridazinyl group, an indolyl group, a quinolyl group, and a morpholino group.

R₁ to R₇ are preferably a hydrogen atom, a halogen atom, a hydroxy group, a substituted or unsubstituted aliphatic hydrocarbon group, a substituted or unsubstituted alicyclic hydrocarbon group, or a substituted or unsubstituted aromatic hydrocarbon group.

R₁ to R₇ are more preferably a substituted or unsubstituted aliphatic hydrocarbon group or an alicyclic hydrocarbon group, further preferably a substituted or unsubstituted C₂₋₈ aliphatic hydrocarbon group or a substituted or unsubstituted C₂₋₈ alicyclic hydrocarbon group, most preferably an n-propyl group, an isopropyl group, an n-butyl group, an isobutyl group, a tert-butyl group, or a cyclopentyl group.

Q₁ to Q₉ are preferably a hydrogen atom, a halogen atom, a hydroxy group, a substituted or unsubstituted aliphatic hydrocarbon group, a substituted or unsubstituted alicyclic hydrocarbon group, or a substituted or unsubstituted aromatic hydrocarbon group.

Q₁ to Q₉ are more preferably a substituted or unsubstituted aliphatic hydrocarbon group or an alicyclic hydrocarbon group, further preferably a substituted or unsubstituted C₂₋₈ aliphatic hydrocarbon group or a substituted or unsubstituted C₂₋₈ alicyclic hydrocarbon group, most preferably an n-propyl group, an isopropyl group, an n-butyl group, an isobutyl group, a tert-butyl group, or a cyclopentyl group.

The present invention also relates to a high refractive-index coating film having a refractive index at a wavelength of 633 nm of 2.3 or more and 4.0 or less, which is obtained from a coating film containing a germanium compound containing a Ge—Ge bond as the backbone thereof by using a technique of [production method of high refractive-index coating film] described below. Further, the present invention also relates to: a pattern-formed coating film composed only of a high refractive-index crystal having a refractive index at a wavelength of 633 nm of 2.3 or more and 4.0 or less and containing a Ge—Ge bond as a main component, which is obtained by using a technique of [production method of pattern and pattern-formed coating film] described below; and a pattern-formed coating film containing, within the same face, a high refractive-index region having a refractive index at a wavelength of 633 nm of 2.3 or more and 4.0 or less and containing a Ge—Ge bond as a main component and a relatively low refractive-index region having the refractive index of 1.4 or more and 1.8 or less and containing a Ge—O—Ge bond as a main component, in which the refractive index difference between the regions is 0.5 to 2.0.

Here, the high refractive-index coating film or the high refractive-index region of the present invention typically includes a high refractive-index coating film or a high refractive-index region having a predetermined refractive index (d) value at a wavelength of 633 nm, for example 1.8 or more or 2.3 or more. Also a coating film or a region achieving a predetermined refractive index (d) value at a wavelength of around 633 nm and having a refractive index close to the refractive index (d) value also at a wavelength of 633 nm corresponds to the high refractive-index coating film or the high refractive-index region of the present invention. In essence, a coating film or a high refractive-index region achieving a predetermined high refractive index (d) value at a wavelength of around 633 nm is satisfactory.

Such a preferred structure of the germanium compound is structures of Formula [2]:

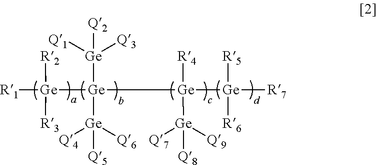

In Formula [2], R′₁, R′₂, R′₃, R′₄, R′₅, R′₆, and R′₇ are independently a group selected from a hydrogen atom, a halogen atom, a hydroxy group, a substituted or unsubstituted aliphatic hydrocarbon group, and a substituted or unsubstituted alicyclic hydrocarbon group.

Q′₁, Q′₂,Q′₃, Q′₄, Q′₅, Q′₆, Q′₇, Q′₈, and Q′₉ are independently a polymer chain forming a Ge—Ge bond or a group selected from a hydrogen atom, a halogen atom, a hydroxy group, a substituted or unsubstituted aliphatic hydrocarbon group, and a substituted or unsubstituted alicyclic hydrocarbon group.

Then, a, b, c, and d are independently an integer including 0 and satisfy a+b+c+d≧1.

Specific examples of the substituted or unsubstituted aliphatic hydrocarbon group and the substituted or unsubstituted alicyclic hydrocarbon group as R′₁, to R′₇ and Q′₁ to Q′₉ include: aliphatic hydrocarbon groups such as a methyl group, an ethyl group, a propyl group, a butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a trifluoromethyl group, a trifluoropropyl group, and a glycidyloxy propyl group; and alicyclic hydrocarbon groups such as a cyclopropyl group, a cyclobutyl group, a cyclopentyl group, a cyclohexyl group, a cycloheptyl group, a cyclooctyl group, a cyclononyl group, a cyclodecyl group, a cycloundecyl group, a cyclododecyl group, a cyclotridecyl group, a cyclotetradecyl group, a cyclopentadecyl group, a cyclohexadecyl group, a cycloheptadecyl group, a cyclooctadecyl group, an adamantyl group, a norbornyl group, and an isobornyl group.

R′₁ to R′₇ are preferably a substituted or unsubstituted C₂₋₈ aliphatic hydrocarbon group or a substituted or unsubstituted C₂₋₈ alicyclic hydrocarbon group, more preferably an n-propyl group, an isopropyl group, an n-butyl group, an isobutyl group, a tert-butyl group, or a cyclopentyl group.

Q′₁ to Q′9 are preferably a substituted or unsubstituted C₂₋₈ aliphatic hydrocarbon group or a substituted or unsubstituted C₂₋₈ alicyclic hydrocarbon group, more preferably an n-propyl group, an isopropyl group, an n-butyl group, an isobutyl group, a tert-butyl group, or a cyclopentyl group.

[Production Method of Germanium Compound]

The production method of a germanium compound used in: the production method of a high refractive-index coating film; the high refractive-index coating film; the pattern-formed coating film composed only of a high refractive-index crystal; the pattern-formed coating film having a large refractive index difference; and the production method of the pattern or the pattern-formed coating film; of the present invention is not particularly limited. However, one example thereof is synthesizing the germanium compound using a halogenated germanium as a raw material through a process of forming a Ge—Ge bond as a first process and a process of converting a Ge—X (X is a halogen atom) bond into a Ge—C bond (Ge-carbon atom bond) as a second process.

Examples of the halogenated germanium used as the above raw material include a tetrahalogenated germanium, a trihalogenated germanium, and a dihalogenated germanium. These halogenated germanium may be used individually or in combination of two or more types thereof.

The process of forming a Ge—Ge bond that is the first process can be performed, for example by reacting the halogenated germanium in the presence of an alkali metal or an alkaline earth metal.

Although examples of the alkali metal or the alkaline earth metal used here include lithium, sodium, and magnesium, magnesium is preferably used in terms of mild reactivity.

The process of converting a Ge—X bond into a Ge—C bond that is the second process is in other words a process of forming a bond between a germanium atom and a carbon atom of an organic group and can be performed, for example by reacting a Ge—X bond remaining in a compound obtained by the first process with a halogenated organic compound in the presence of metal magnesium.

The halogenated organic compounds may be used individually or in combination of two or more types thereof. Examples of the halogenated organic compound include halides of aliphatic hydrocarbons, halides of alicyclic hydrocarbons, and halides of aromatic hydrocarbons. Although the halogen element of the halogenated organic compound is not particularly limited, chlorides and bromides are preferred.

Specific examples of such a halogenated organic compound include: halogenated aliphatic hydrocarbons such as bromoethane, 1-chloropropane, 1-bromopropane, 2-chloropropane, 2-bromopropane, 2-chloropropene, 2-bromopropene, 3-chloropropene, 3-bromopropene, 1-bromo-1-propene, 1-chlorobutane, 1-bromobutane, 2-chlorobutane, 2-bromobutane, 1-chloro-2-methylpropane, 1-bromo-2-methylpropane, 2-chloro-2-methylpropane, 2-bromo-2-methylpropane, 3-chloro-1-butene, 3-chloro-2-methylpropene, 2-bromo-2-butene, 4-bromo-1-butene, 1-chloropentane, 1-bromopentane, 2-chloropentane, 2-bromopentane, 3-bromopentane, 1-chloro-3-methylbutane, 1-bromo-3-methylbutane, 2-chloro-2-methylbutane, 2-bromo-2-methylbutane, 5-chloro-1-pentyne, 1-chlorohexane, 1-bromohexane, 6-chloro-1-hexene, 6-bromo-1-hexene, 6-chloro-1-hexyne, 1-chloroheptane, 1-bromoheptane, 1-chlorooctane, 1-bromooctane, 3-(chloromethyl)heptane, 1-chlorononane, 1-bromononane, 1-chlorodecane, 1-bromodecane, 11-chloro-1-undecene, 1-chlorododecane, 1-bromododecane, 1-chlorotetradecane, 1-bromotetradecane, 1-chlorohexadecane, 1-bromohexadecane, 1-chlorooctadecane, 1-bromooctadecane, and 1-chloro-9-octadecene; halogenated alicyclic hydrocarbons such as bromocyclopropane, chlorocyclobutane, bromocyclobutane, chlorocyclopentane, bromocyclopentane, 1-chloro-1-cyclopentene, chlorocyclohexane, bromocyclohexane, 1-chloroadamantane, 1-bromoadamantane, 2-bromoadamantane, 2-chloronorbornane, and 2-bromonorbornane; and halogenated aromatic hydrocarbons such as chlorobenzene, bromobenzene, 2-chlorotoluene, 2-bromotoluene, 3-chlorotoluene, 3-bromotoluene, 4-chlorotoluene, 4-bromotoluene, 2-chloro-1,3-dimethylbenzene, 2-chloro-1,4-dimethylbenzene, 3-chloro-1,2-dimethylbenzene, 4-chloro-1,2-dimethylbenzene, 1-bromo-3,5-dimethylbenzene, 1-chloro-2-fluorobenzene, 1-chloro-3-fluorobenzene, 1-chloro-4-fluorobenzene, 1-bromo-2-fluorobenzene, 1-bromo-3-fluorobenzene, 1-bromo-4-fluorobenzene, 2-chloro-4-fluorotoluene, 2-bromo-4-fluorotoluene, 2-chloro-5-fluorotoluene, 2-bromo-5-fluorotoluene, 2-chloro-6-fluorotoluene, 4-bromo-2-fluorotoluene, 4-bromo-3-fluorotoluene, 5-chloro-2-fluorotoluene, 5-bromo-2-fluorotoluene, 1-bromo-2,3-difluorobenzene, 1-chloro-2,4-difluorobenzene, 1-bromo-2,4-difluorobenzene, 1-chloro-2,5-difluorobenzene, 1-bromo-2,5-difluorobenzene, 1-chloro-3,4-difluorobenzene, 1-bromo-3,4-difluorobenzene, 1-chloro-3,5-difluorobenzene, 1-bromo-3,5-difluorobenzene, chloropentafluorobenzene, bromopentafluorobenzene, benzyl chloride, benzyl bromide, α-bromo-2,3-difluorotoluene, α-bromo-2,4-difluorotoluene, α-bromo-2,5-difluorotoluene, α-bromo-2,6-difluorotoluene, α-bromo-3,4-difluorotoluene, α-bromo-3,5-difluorotoluene, 1-chloro-1-phenylethane, 1-chloro-3-phenylpropane, 2-bromobiphenyl, 3-bromobiphenyl, 4-bromobiphenyl, 1-chloronaphthalene, 1-bromonaphthalene, 1-bromo-2-methylnaphthalene, 2-chloronaphthalene, 2-bromonaphthalene, 1-(chloromethyl)naphthalene, 2-(bromomethyl)naphthalene, 1-chloroanthracene, 2-chloroanthracene, 9-chloroanthracene, 9-bromoanthracene, 2-chlorostyrene, 2-bromostyrene, 3-chlorostyrene, 3-bromostyrene, 4-chlorostyrene, 4-bromostyrene, α-bromostyrene, β-bromostyrene, chlorotriphenylmethane, bromotriphenylmethane, bromotriphenylethylene, 2-chloropyridine, 2-bromopyridine, 3-chloropyridine, 3-bromopyridine, 2-methyl-4-methylpyridine, 2-methyl-5-methylpyridine, 2-chloropyrazine, 2-chloroquinoline, 3-bromoquinoline, 4-bromoisoquinoline, 8-chloroquinoline, 8-bromoquinoline, 4-chloroindole, 4-bromoindole, 5-chloroindole, 5-bromoindole, 6-chloroindole, 6-bromoindole, 7-chloroindole, 7-bromoindole, 2-chlorothiophene, 2-bromothiophene, 3-chlorothiophene, and 3-bromothiophene.

In the above exemplified production method, the second process can be performed in advance to be followed by the first process. In this case, there is obtained a germanium compound having a relatively small number of branches and being near to a straight-chain.

As the reaction solvent used for the reaction, various solvents may be used so long as the solvent does not affect the reaction. Among them, there are preferably usable ethers such as tetrahydrofuran, diethyl ether, diisopropyl ether, and dibutyl ether.

<Production Methods of High Refractive-Index Coating Film, Pattern-Formed Coating Film Composed Only of High Refractive-Index Crystal, and Pattern-Formed Coating Film Having Refractive Index Difference of 0.5 to 2.0>

### [Production Method of High Refractive-Index Coating Film]

The production method of a high refractive-index coating film of the present invention includes a process of producing a coating film containing a germanium compound and a process of baking the coating film under vacuum or in an inert gas atmosphere.

Although the detailed mechanism through which a high refractive index is obtained by the production method of the present invention is not apparent, it is considered that through the above processes, an organic group is eliminated from a germanium compound to elevate the germanium concentration and to newly form a bond between germanium atoms, and the bond between germanium atoms further grows to generate a germanium fine crystal, so that a high refractive-index thin film (coating film) is formed. That is, the coating film is a coating film containing a high refractive-index crystal containing a Ge—Ge bond as a main component. The germanium fine crystal in which the bond between germanium atoms is increased is considered to provide extremely high oxidation resistance. That is, the generation of a germanium fine crystal in the film is regarded as enhancing the oxidation resistance. Therefore, the coating film produced by the method of the present invention becomes a high refractive-index coating film having extremely high resistance (photo-oxidation resistance) against the oxidation of germanium caused by irradiating with light and having high stability.

[Production Method of Pattern-Formed Coating Film]

On the other hand, in the forming method of the pattern-formed coating film composed only of a high refractive-index crystal having a refractive index at a wavelength of 633 nm of 2.3 or more and 4.0 or less and containing a Ge—Ge bond as a main component, the pattern-formed coating film is obtained through: a process of producing a coating film containing a germanium compound containing a Ge—Ge bond as the backbone thereof; a process of irradiating the coating film with a radiation for transferring a pattern, for example of irradiating the coating film with a radiation having a pattern by a mask exposure or a coherent light exposure; and then baking the coating film under vacuum or in an inert gas atmosphere.

As the forming method of the pattern-formed coating film containing, within the same face, a high refractive-index region having a refractive index at a wavelength of 633 nm of 2.3 or more and 4.0 or less and containing a Ge—Ge bond as a main component and a relatively low refractive-index region having the refractive index of 1.4 or more and 1.8 or less and containing a Ge—O—Ge bond as a main component, in which the refractive index difference between the regions is 0.5 to 2.0, the pattern-formed coating film is obtained in the same manner as described above through: a process of irradiating the coating film with a radiation for transferring a pattern, for example of irradiating the coating film with a radiation having a pattern by a mask exposure or a coherent light exposure; and then baking the coating film under vacuum or in an inert gas atmosphere. Here, the inert gas atmosphere may contain a reductive gas such as hydrogen, and in this case, the content of the reductive gas is preferably 1 to 10% as a gas partial pressure.

It is possible to control which pattern-formed coating film is to be obtained based on the conditions for baking.

In detail, first, by irradiating the coating film with a radiation for transferring a pattern, a mask-exposed portion or a portion with a large illuminance where coherent lights reinforce each other is selectively oxidized to form a relatively low refractive-index region containing a Ge—O—Ge bond as a main component. On the other hand, a germanium compound containing a Ge—Ge bond as the backbone thereof that is a mask unirradiated portion or a dark portion in which the lights counteract each other in the coherent light exposure becomes a region in which the germanium concentration is elevated by an elimination of an organic group through the subsequent baking process, and further becomes a region composed only of a high refractive-index crystal having a refractive index of 2.3 or more and 4.0 or less and containing a Ge—Ge bond as a main component in which the bond between germanium atoms further grows to generate a germanium fine crystal.

In this baking process, when the coating film is baked at 400° C. or more, the region containing a Ge—O—Ge bond as a main component gradually disappears not only by the elimination of an organic group, but also by the thermal decomposition of all components, that is, the relatively low refractive-index region disappears and the region composed only of a high refractive-index crystal containing a Ge—Ge bond as a main component remains.

On the other hand, when the coating film is baked at less than 400° C., in the region containing a Ge—O—Ge bond as a main component, the elimination of an organic group is preferentially caused, so that although the formed amount varies depending on the time condition, there is obtained a pattern in which, within the same face, a region having a refractive index of 2.3 or more and 4.0 or less and containing a Ge—O—Ge bond as a main component and a region containing a Ge—Ge bond as a main component coexist.

In the present invention, specific examples of the process of irradiating the coating film with a radiation for transferring a pattern include an irradiation with a radiation having a pattern by an exposure using a mask or a coherent light exposure.

In the process of producing a coating film containing a germanium compound, the coating film containing a germanium compound is ordinarily produced by applying a solution of the germanium compound onto a substrate and by drying the solution.

The solvent used at this time is not particularly limited so long as the solvent is a volatile solvent capable of dissolving the germanium compound in an amount of 1% by mass or more and having a boiling point of 300° C. or less, and specific examples thereof include: aliphatic hydrocarbon compounds such as heptane, hexane, pentane, octane, nonane, decane, undecane, dodecane, cyclopentane, cyclohexane, cycloheptane, and decalin; aromatic hydrocarbon compounds such as benzene, toluene, ethylbenzene, xylene, cumene, and mesitylene; ketone compounds such as acetone, methyl ethyl ketone, diethyl ketone, methyl propyl ketone, methyl isobutyl ketone, cyclopentanone, cyclohexanone, cycloheptanone, cyclooctanone, acetophenone, and propiophenone; ether compounds such as diethyl ether, diisopropyl ether, dibutyl ether, tert-butyl methyl ether, cyclopentyl methyl ether, anisole, tetrahydrofuran, tetrahydropyran, dioxane, ethylene glycol dimethyl ether, and triethylene glycol dimethyl ether; ester compounds such as methyl acetate, ethyl acetate, propyl acetate, butyl acetate, pentyl acetate, hexyl acetate, cyclohexyl acetate, phenyl acetate, benzyl acetate, methyl propionate, ethyl propionate, methyl lactate, ethyl lactate, butyl lactate, pentyl lactate, methyl valerate, ethyl valerate, methyl benzoate, ethyl benzoate, propyl benzoate, butyl benzoate, γ-butyrolactone, and propylene glycol monomethyl ether acetate; halogen-containing compounds such as dichloromethane, chloroform, carbon tetrachloride, 1,2-dichloroethane, chlorobenzene, dichlorobenzene, and bromoform; halogen-containing compounds such as bromobenzene; nitrogen-containing compounds such as acetonitrile, propionitrile, benzonitrile, dimethylformamide, dimethylacetamide, and N-methyl-2-pyrrolidone; and sulfur-containing compounds such as dimethylsulfoxide and ethyl methanesulfonate.

Among these solvents, preferred are toluene, tetrahydrofuran, chloroform, and chlorobenzene.

When the content (concentration) of the germanium compound in the germanium compound solution is less than 1% by mass, the obtained coating film has an extremely small film thickness, and a homogeneous high refractive film may not be obtained by baking, so that the content is preferably 1% by mass or more, more preferably 5% by mass or more. By making the content 5% by mass or more, a high refractive-index coating film having a stable film thickness can be easily obtained. On the other hand, when the content is more than 50% by mass, the germanium compound solution may have poor fluidity, so that a homogeneous thin film may not be obtained. Accordingly, the upper limit of the concentration is preferably 50% by mass or less, more preferably 30% by mass or less.

In the baking process, when the oxygen concentration is high, germanium is oxidized, and consequently, components lowering the refractive index increase, so that the oxygen partial pressure is preferably low. Accordingly in the present invention, under vacuum is preferably under less than 10 torr (1.33×10² Pa), more preferably under less than 1 torr (1.33×10² Pa), and in the case of in an inert gas atmosphere, the oxygen partial pressure is preferably less than 2.1 torr (2.80×10² Pa), more preferably less than 0.2 torr (2.67×10¹ Pa). Under vacuum, an organic group of the germanium compound can be easily eliminated, which is more preferred.

In any one of the production method of the high refractive-index coating film and the production method of the pattern-formed coating film, the temperature for the baking process is preferably a temperature of 200° C. or more, and for obtaining a thin film having a higher refractive index, the temperature is more preferably a temperature of 250° C. or more. Although the highest temperature is 1,000° C. or less, when the temperature is a temperature of more than 500° C., the obtained coating film may be colored, so that the temperature is preferably a temperature of 500° C. or less, more preferably a temperature of 350° C. or less. The baking time is preferably 10 minutes to 2 hours.

The high refractive-index coating film obtained according to the production method of the present invention is a high refractive-index coating film having a refractive index at a wavelength of 633 nm of 1.8 or more. However, by selecting the above production conditions, there can be obtained a thin film having an extremely high refractive index of 2.3 or more and 4.0 or less. The obtained high refractive-index coating film has extremely high photo-oxidation resistance.

The formed coating film composed only of a high refractive-index crystal or the pattern-formed coating film having a refractive index difference of 0.5 to 2.0 both obtained by the production method of the present invention has an extremely large refractive index difference relative to air or an extremely large refractive index difference within the same face. Therefore, the pattern-formed coating film can be applied to the production of various photo-devices such as an optical waveguide and a photonic crystal that have large light confining capacity.

### EXAMPLES

The present invention will be more specifically described referring to Examples. However, Synthesis Examples and Examples below should not be construed as limiting the scope of the present invention.

[Apparatus Used for Weight Average Molecular Weight (Mw) and Molecular Weight Distribution (Mw/Mn)]

Apparatus: Normal temperature gel permeation chromatography (GPC) apparatus “HLC-8220GPC” manufactured by Tosoh Corporation, column (KF804L+KF805L) manufactured by Shodex Corporation

Column temperature: 40° C.

Eluant: tetrahydrofuran

Flow rate: 1.0 ml/min

Standard sample for preparing calibration curve: standard polystyrene for GPC molecular weight 2,330,000, 723,000, 219,000, 52,200, 13,000, and 1,260

[Measuring Method of Film Thickness and Refractive Index at 633 nm (Interference Spectrum Method)]

For the measurement of the refractive index by the interference spectrum method, the apparatus shown in FIG. 5 was used. As an optical microscope, a microscope optical fiber adaptor, and a spectroscope, the followings were used.

Optical microscope: “BX51M” manufactured by Olympus Corporation

Microscope optical fiber adaptor: “A6399” manufactured by Hamamatsu Photonics K.K.

Cooling-type multi-channel spectroscope: (CCD part: “DV401-BV” manufactured by Andor Co., Ltd., spectroscope part: “MS257” manufactured by Oriel Corporation)

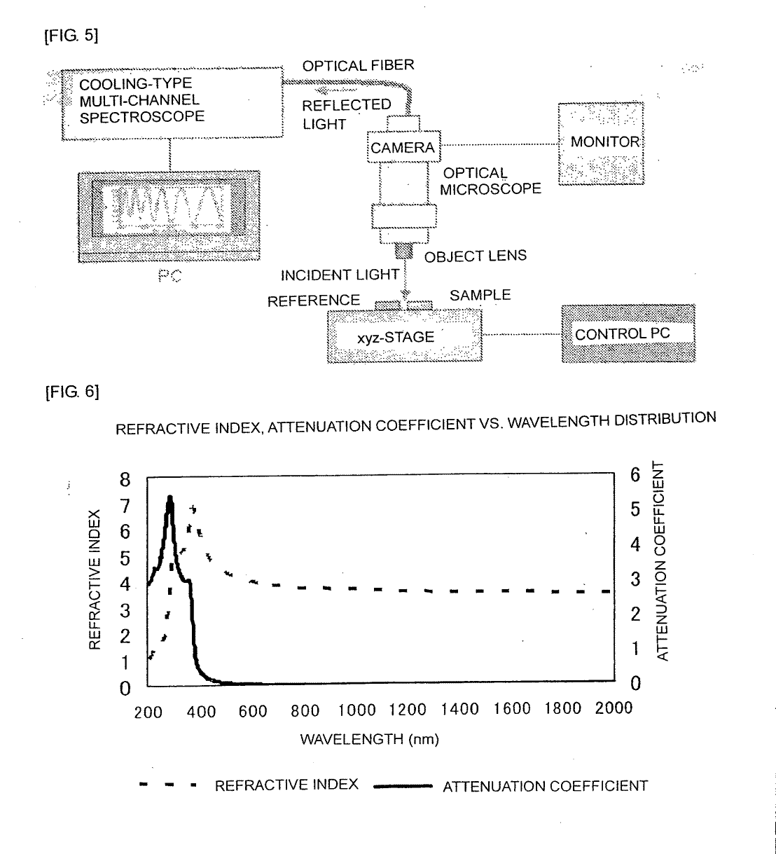

A reflected light from an optical microscope was introduced into an optical fiber of a cooling-type multi-channel spectroscope through a microscope optical fiber adaptor and the measurement of the interference spectrum was performed referring to a silicon substrate. The calculation of the refractive index and the film thickness of a thin film from the interference spectrum was performed by nonlinear fitting of the interference spectrum according to the same method as in “M. Urbanek et al, “Instrument for thin film diagnostics by UV spectroscopic reflectometry”, Surface and Interface Analysis, vol. 36, p. 1102-1105 (2004)”. For the calculation of the refractive index and the film thickness by nonlinear fitting of the interference spectrum, there were used optical thin film designing software FilmWizard manufactured by SCI, Inc. and data of the wavelength distribution of the refractive index and the attenuation coefficient of silicon that is attached to the software (see FIG. 6).

### Synthesis Example 1

### Synthesis of Germanium Compound (PGePh)

While stirring germanium tetrachloride (6.83 g) and anhydrous tetrahydrofuran (80 ml) in a flask under a nitrogen atmosphere, magnesium (6.22 g) was added thereto and the resultant reaction mixture was stirred at a temperature of 10° C. for 1 hour to be subjected to the reaction. Then thereto, bromobenzene (5.02 g) was added and the resultant reaction mixture was stirred at a temperature of 10° C. for 1 hour to be subjected to the reaction. To the reaction mixture, bromobenzene (5.02 g) was added again and the reaction mixture was stirred at a temperature of 10° C. for 1 hour and at a temperature of 50° C. for 2 hours to be subjected to the reaction. Further, the reaction mixture was stirred at room temperature (temperature of 25° C.) all day and night to be subjected to the reaction. The reaction solution was precipitated in methanol and the resultant precipitate was filtered and isolated. By this reprecipitation-purification, a germanium compound (PGePh) was obtained. The weight average molecular weight and the molecular weight distribution of PGePh were found to be 1,130 and 2.22, respectively.

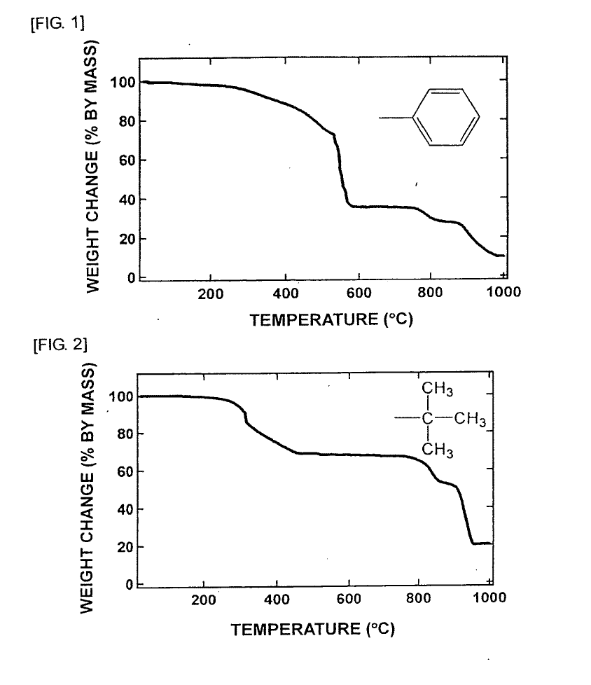

Further, the obtained germanium compound (PGePh) was subjected to a thermogravimetric analysis in a helium (He) atmosphere (oxygen: 4×10⁻³ torr (5.33×10⁻¹ Pa) or less). For the analysis, a micro thermogravimetric analysis apparatus “TGA-50” manufactured by Shimadzu Corporation was used. The result thereof is shown in FIG. 1. According to this, there was obtained a result that the weight loss of the compound gradually started from around 200° C. and a sudden weight loss was caused at around 550° C., which indicated an elimination of a phenyl group by a thermal decomposition.

### Synthesis Example 2

### Synthesis of Germanium Compound (PGetBu)

While stirring germanium tetrachloride (6.83 g) and anhydrous tetrahydrofuran (80 ml) in a flask under a nitrogen atmosphere, magnesium (6.22 g) was added thereto and the resultant reaction mixture was stirred at a temperature of 10° C. for 1 hour to be subjected to the reaction. Then thereto, tert-butyl bromide (4.38 g) was added and the resultant reaction mixture was stirred at a temperature of 10° C. for 1 hour to be subjected to the reaction. To the reaction mixture, tert-butyl bromide (4.38 g) was added again and the reaction mixture was stirred at a temperature of 10° C. for 1 hour and at a temperature of 50° C. for 2 hours to be subjected to the reaction. Further, the reaction mixture was stirred at room temperature (temperature of 25° C.) all day and night to be subjected to the reaction. The reaction solution was precipitated in methanol and the resultant precipitate was filtered and isolated. By this reprecipitation-purification, a germanium compound (PGetBu) was obtained. The weight average molecular weight and the molecular weight distribution of PGetBu were found to be 2,862 and 1.65, respectively.

Further, the obtained germanium compound (PGetBu) was subjected to a thermogravimetric analysis in a helium (He) atmosphere (oxygen: 4×10⁻³ torr (5.33×10⁻¹ Pa) or less). For the analysis, a micro thermogravimetric analysis apparatus “TGA-50” manufactured by Shimadzu Corporation was used. The result thereof is shown in FIG. 2. According to this, there was obtained a result that the weight loss of the compound gradually started from around 150° C. and a sudden weight loss was caused at around 300° C., which indicated an elimination of a tert-butyl group by a thermal decomposition.

### Example 1

### FT-IR Measurement of Germanium Compound (PGePh) Thin Film

A solution of a germanium compound (PGePh) obtained in the same manner as in Synthesis Example 1 was prepared so that the germanium compound had a content of 10% by mass in a solvent of toluene, and a germanium compound (PGePh) thin film was formed on a silicon substrate by a spin coating method (rotation number of 2,000 rpm×30 sec). Next, in a quartz tube fitted in a tubular electric oven, a sample of the silicon substrate on which the film was formed was fitted. Using a vacuum exhaust apparatus including a turbo molecular pump (“TMH064” manufactured by Pfeiffer Corporation) and a rotary pump (“2015SD” manufactured by Alcatel Corporation), vacuum exhaust was performed until a vacuum degree exceeds 5×10⁻⁶ torr (6.67×10⁻⁴ Pa). Then, the temperature of the sample was elevated at a temperature elevation rate of 20° C./min to a temperature of 200° C. and to a temperature of 300° C., and then at each of these temperatures, the sample was subjected to heating treatment for 30 minutes.

The refractive index at a wavelength of 633 nm and the film thickness of each of the thus obtained thin films before the heating treatment, after the heating treatment at 200° C. for 30 minutes, and after the heating treatment at 300° C. for 30 minutes are shown in Table 1. Here, the measurement of the refractive index and the film thickness of the thin film was performed using the above interference spectrum method.

TABLE 1

| | | | After heating |
|---|---|---|---|
| | Before heating | After heating | treatment |
| | treatment | treatment at 200° C. | at 300° C. |
| Refractive index | 1.735 | 1.732 | 1.827 |
| Film thickness (nm) | 510 | 390 | 220 |

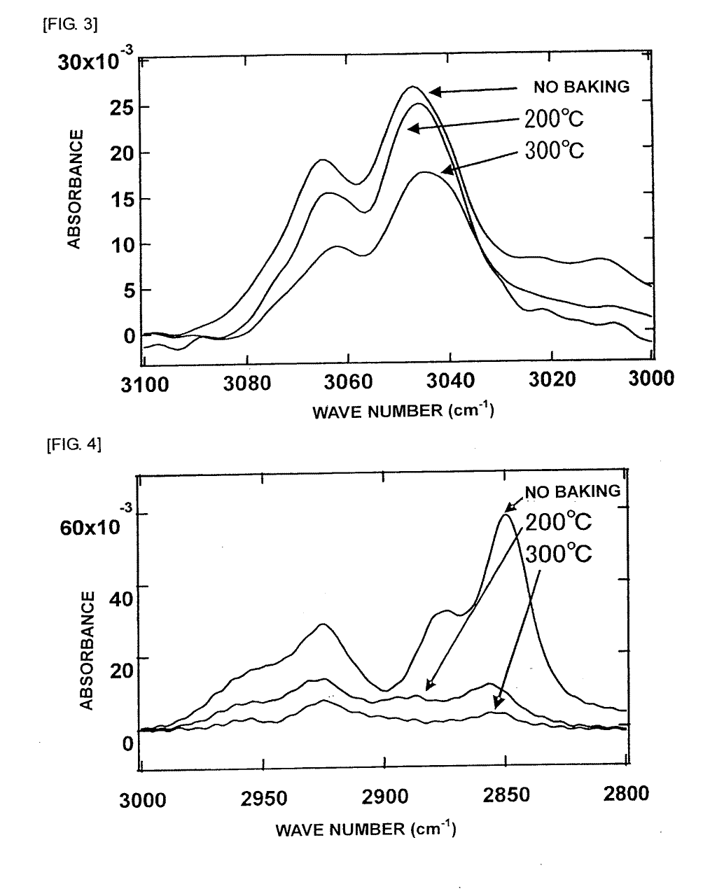

With respect to each of the thus obtained thin films before the heating treatment, after the heating treatment at 200° C. for 30 minutes, and after the heating treatment at 300° C. for 30 minutes, the FT-IR spectrum was measured. For the measurement, “FT/IR-4200” manufactured by JASCO Corporation was used. The result thereof is shown in FIG. 3.

As shown in FIG. 3, there is a small difference of the spectrum between the thin film before the heating treatment and the thin film after the heating treatment at 200° C., so that it was indicated that until a temperature of 200° C., elimination of a phenyl group due to thermal decomposition does not remarkably occur.

Corresponding to a weight loss from around 200° C. shown in the result of the above thermogravimetric analysis (FIG. 1), in the FT-IR spectrum of the thin film after the heating treatment at 300° C., there was observed a reduction of the absorbance of about 25% ascribed to C—H of a phenyl group.

### Example 2

### FT-IR Measurement of Germanium Compound (PGetBu) Thin Film

A solution of a germanium compound (PGetBu) obtained in the same manner as in Synthesis Example 2 was prepared so that the germanium compound had a content of 10% by mass in a solvent of toluene, and a germanium compound (PGetBu) thin film was formed on a silicon substrate by a spin coating method (rotation number of 2,000 rpm×30 sec). Next, in a quartz tube fitted in a tubular electric oven, a sample of the silicon substrate on which the film was formed was fitted. Using a vacuum exhaust apparatus including a turbo molecular pump (“TMH064” manufactured by Pfeiffer Corporation) and a rotary pump (“2015SD” manufactured by Alcatel Corporation), vacuum exhaust was performed until a vacuum degree exceeds 5×10⁻⁶ torr (6.67×10⁻⁴ Pa). Then, the temperature of the sample was elevated at a temperature elevation rate of 20° C./min to a temperature of 200° C. and to a temperature of 300° C., and then at each of these temperatures, the sample was subjected to heating treatment for 30 minutes.

The refractive index at a wavelength of 633 nm and the film thickness of each of the thus obtained thin films before the heating treatment, after the heating treatment at 200° C. for 30 minutes, and after the heating treatment at 300° C. for 30 minutes are shown in Table 2. Here, the measurement of the refractive index and the film thickness of the thin film was performed using the interference spectrum method as with Example 1.

TABLE 2

| | | | After heating |
|---|---|---|---|
| | Before heating | After heating | treatment |
| | treatment | treatment at 200° C. | at 300° C. |
| Refractive index | 1.688 | 2.176 | 2.824 |
| Film thickness (nm) | 180 | 70 | 60 |

With respect to each of the thus obtained thin films before the heating treatment, after the heating treatment at 200° C. for 30 minutes, and after the heating treatment at 300° C. for 30 minutes, the FT-IR spectrum was measured. For the measurement, “FT/IR-4200” manufactured by JASCO Corporation was used. The result thereof is shown in FIG. 4.

As shown in FIG. 4, by the heating treatment at a temperature of 200° C., the absorbance suddenly decreased to 50% or less. This corresponded to a weight loss from around 150° C. shown in the result of the above thermogravimetric analysis (FIG. 2).

From the results of the thermogravimetric analysis and the FT-IR spectrum measurement after the heating treatment under vacuum of the above two types of the germanium compound (PGePh) and the germanium compound (PGetBu), it was indicated that the germanium compound having an aliphatic substituent (Example 2: PGetBu) is thermally decomposed more easily at a temperature lower than a temperature at which the germanium compound having an aromatic substituent (Example 1: PGePh) is thermally decomposed. That is, at a lower temperature, an organic substituent is eliminated from the Ge polymer skeleton.

The germanium compound having an aliphatic substituent (Example 2: PGetBu) exhibited a remarkable increase of the refractive index of near 0.4 after the heating treatment at 200° C. This corresponds to the result that in the thermogravimetric analysis and the FT-IR spectrum after the heating treatment under vacuum, the absorbance decreased suddenly to 50% or less by the heating treatment at 200° C.

Further, according to the elevation of the heating treatment temperature, the refractive index increased to a value of around 2.5. This increase of the refractive index corresponds to the measurement result of a sudden weight loss due to an elimination of a tert-butyl group at around 300° C. in the above thermogravimetric analysis.

From the measurement result of a change in the refractive index with the heating treatment under vacuum of the two types of the germanium compound (PGePh) and the germanium compound (PGetBu), it was indicated that the germanium compound having an aliphatic substituent has a higher pyrolytic property than that of the germanium compound having an aromatic substituent (thermally decomposed more easily at a low temperature), and by the heating treatment, the germanium compound having aliphatic substituent can produce a higher refractive-index thin film.

### Reference Example 1

With respect to a thin film obtained in the same manner as in Example 1 before the heating treatment after spin coating, the refractive index was measured by the interference spectrum method (nonlinear fitting of interference spectrum) and the prism coupler method. For the measurement of the refractive index by the prism coupler method, a film thickness/refractive index measuring apparatus (Model 2010 prism coupler) manufactured by Metricon Corporation was used and the measurement at a wavelength of an He—Ne laser of 633 nm was performed. The obtained result is shown in Table 3.

As shown in Table 3, the measurement values of the refractive index and the film thickness obtained by the interference spectrum method and by the prism coupler method were substantially the same. From this result, there was confirmed the reliability of the measurement values of the refractive index and the film thickness obtained by fitting of the interference spectrum.

TABLE 3

| | Interference | Prism |
|---|---|---|
| | spectrum method | coupler method |
| Refractive index | 1.735 | 1.755 |
| Film thickness (nm) | 510 | 520 |

### Example 3

### Irradiation of Germanium Compound (PGetBu) Thin Film with Ultraviolet Ray and Refractive Index

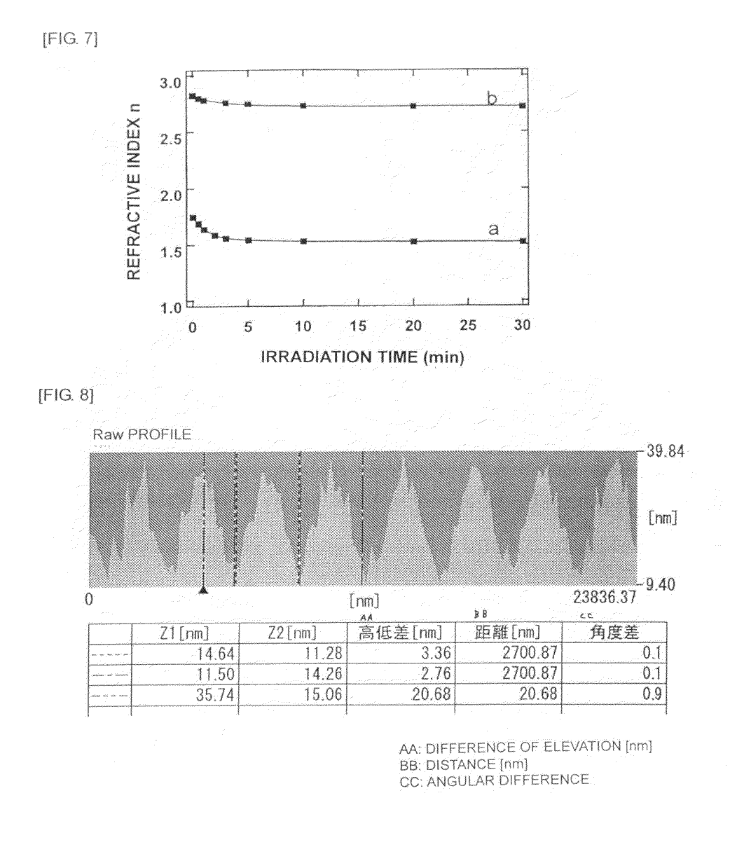

By the same operation as in Example 2, a thin film before the heating treatment after spin coating and a thin film subjected to the heating treatment at a temperature of 300° C. were prepared and each of the obtained thin films was irradiated with an electromagnetic wave. Here, in the ultraviolet ray irradiation, as the electromagnetic wave, an ultraviolet ray was selected and the ultraviolet ray irradiation was performed using a mercury xenon lamp light source (mercury xenon lamp “L2570”, power source “C4263”, lamp house “E7536”; manufactured by Hamamatsu Photonics K.K.) and a color filter (“UTVA-330”; manufactured by Sigma Koki Co., Ltd.; transmitting a 230 to 420 nm region). The irradiating power density during the irradiation was always 6 mW/cm². The refractive index of each thin film was measured by the interference spectrum method. The result of the refractive index measured per each irradiating time is shown in FIG. 7.

As shown in FIG. 7, in the PGetBu thin film (FIG. 7A) before the heating treatment after spin coating, the refractive index decreased 0.2 by a light irradiation for 30 minutes and the refractive index lowered to 1.52, while the PGetBu thin film (FIG. 7B) subjected to the heating treatment at 300° C. under vacuum maintained a high refractive index value of 2.5 or more even after a light irradiation for 30 minutes.

### Example 4

### Preparation of Coating Film of Germanium Compound (PGetBu) Thin Film in which Pattern is Formed

A solution of a germanium compound (PGetBu) obtained by the same operation as in Synthesis Example 2 was prepared so that the germanium compound had a content of 10% by mass in a solvent of toluene, and a germanium compound (PGetBu) thin film was formed on a quartz substrate by a spin coating method (rotation number of 2,000 rpm×30 sec). This germanium compound (PGetBu) thin film was irradiated with a mercury xenon lamp light source (mercury xenon lamp “L2570”, power source “C4263”, lamp house “E7536”; manufactured by Hamamatsu Photonics K.K.) in an illuminance of 26 mW/cm² through a photomask (2.5 μm line & space) for 30 minutes to form a micro-pattern containing a light-irradiated portion that contains a germanium oxide as a main component and an unirradiated portion that contains a germanium compound (PGetBu). FIG. 8 shows the result of the line profile for which a pattern of the film was measured by AFM.

The film thickness of this film was measured with a stylus profiler and found to be 351 nm (light irradiated portion) before the light irradiation and 368 nm (light unirradiated portion) after the light irradiation. The amount of increase in the film thickness of the light irradiated portion that contains a germanium oxide as a main component by the light irradiation was found to be 17 nm. This measurement result substantially agreed with the AFM measurement result (20 nm) shown in FIG. 8.

This film was subjected to vacuum exhaust using a vacuum exhaust apparatus that includes a turbo molecular pump (“TMH064” manufactured by Pfeiffer Corporation) and a rotary pump (“2015SD” manufactured by Alcatel Corporation) until a vacuum degree exceeds 5×10⁻⁶ torr (6.67×10⁻⁴ Pa). Then, the temperature of the film was elevated at a temperature elevation rate of 20° C./min to a temperature of 300° C., and then, the film was subjected to heating treatment for 30 minutes.

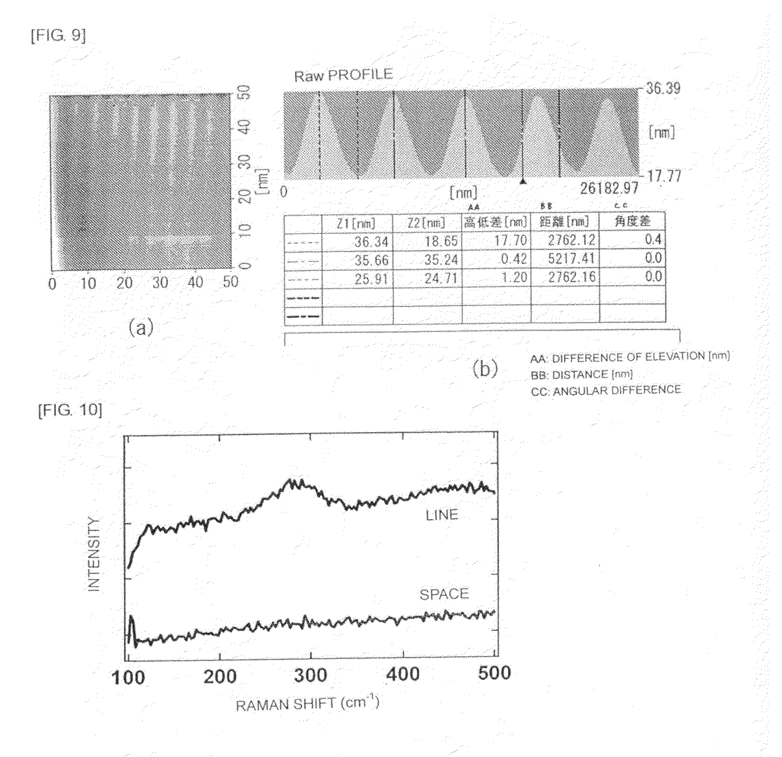

In FIG. 9, the results of an AFM image (FIG. 9A) and a line profile (FIG. 9B) obtained by measuring a pattern of the thus obtained film after the heating treatment by AFM are shown.

In FIG. 10, the results of the measurements of a Raman spectrum for a line portion and a space portion of the film after the heating treatment are shown. As shown in FIG. 10, it could be confirmed that the crystallization of germanium in an unirradiated portion (line) was progressed.

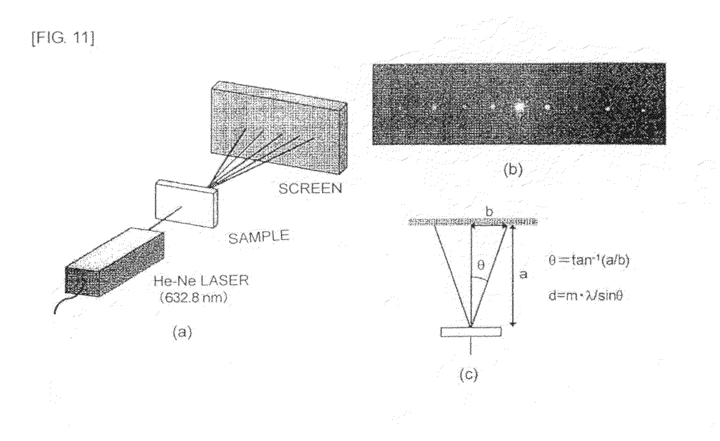

The characteristics of the thus obtained pattern in which a region containing a Ge—O—Ge bond as a main component and a region containing a Ge—Ge bond as a main component coexisted were confirmed using an apparatus shown in FIG. 11A. There could be observed three or more dimensional extremely strong diffraction images (see FIG. 11B) induced by a large refractive index. Thus, it could be confirmed that a diffraction grating was formed. From the Bragg's diffraction equation shown in FIG. 11C, a grating period d of the obtained diffraction image was calculated and found to be 5.0 μm, which agreed well with the photomask (2.5 μm line & space) with which the pattern was formed.

### INDUSTRIAL APPLICABILITY

The high refractive-index coating film produced according to the present invention is soluble in a solvent, has high moldability, high film-formation properties, and a high refractive index of 1.8 or more and further 2.3 or more, and can be converted into a chemically stable thin film. Thus, the high refractive-index coating film is useful as a high-density material for a photoelectronic device or a large-capacity recording material, and a method for forming such a high refractive-index coating film is industrially useful.

A coating film in which a pattern composed only of a high refractive-index crystal is formed or a coating film in which a pattern having a refractive index difference of 0.5 to 2.0 is formed that is obtained according to the present invention, has an extremely large refractive index difference. Therefore, the coating film is useful as a material for various photo-devices such as an optical waveguide, a photonic crystal, a microlens, and a light diffraction grating.

1. A production method of a high refractive-index coating film, the production method comprising:
producing a coating film containing a germanium compound containing a Ge—Ge bond as a backbone thereof; and
baking the coating film under vacuum or in an inert gas atmosphere.

2. The production method of a high refractive-index coating film according to claim 1, wherein the germanium compound is a compound of Formula [1]: 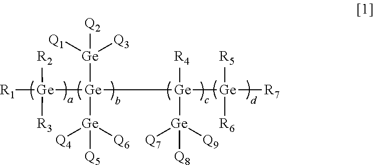
(where R₁, R₂, R₃, R₄, R₅, R₆, and R₇ are independently a group selected from a group consisting of a hydrogen atom, a halogen atom, a hydroxy group, and a substituted or unsubstituted aliphatic hydrocarbon group, alicyclic hydrocarbon group and aromatic hydrocarbon group; Q₁, Q₂, Q₃, Q₄, Q₅, Q₆, Q₇, Q₈, and Q₉ are independently a polymer chain forming a Ge—Ge bond or a group selected from a group consisting of a hydrogen atom, a halogen atom, a hydroxy group, and a substituted or unsubstituted aliphatic hydrocarbon group, alicyclic hydrocarbon group and aromatic hydrocarbon group; and a, b, c, and d are independently an integer including 0 and satisfy a+b+c+d≧1).

3. The production method of a high refractive-index coating film according to claim 1, wherein the baking is performed under vacuum of less than 1 torr (1.33×10² Pa).

4. The production method of a high refractive-index coating film according to claim 1, wherein the baking is performed at a baking temperature of 200° C. to 500° C.

5. The production method of a high refractive-index coating film according to claim 1, wherein the coating film is produced by applying a solution of the germanium compound onto a substrate and drying the solution.

6. The production method of a high refractive-index coating film according to claim 5, wherein the content of the germanium compound in the solution of the germanium compound is 1 to 50% by mass.

7. The production method of a high refractive-index coating film according to claim 1, wherein the high refractive-index coating film has a refractive index at a wavelength of 633 nm of 2.3 or more and 4.0 or less.

8. A high refractive-index coating film having a refractive index at a wavelength of 633 nm of 2.3 or more and 4.0 or less, the high refractive-index coating film obtained by baking a coating film containing a germanium compound containing a Ge—Ge bond as a backbone thereof under vacuum or in an inert gas atmosphere.

9. The high refractive-index coating film according to claim 8, wherein the germanium compound is a compound of Formula [2]: 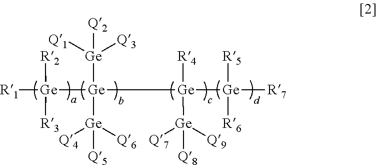
(where R′₁, R′₂, R′₃, R′₄, R′₅, R′₆, and R′₇ are independently a group selected from a hydrogen atom, a halogen atom, a hydroxy group, and a substituted or unsubstituted aliphatic hydrocarbon group and alicyclic hydrocarbon group;
Q′₁, Q′₂, Q′₃, Q′₄, Q′₅, Q′₆, Q′₇, Q′₈, and Q′₉ are independently a polymer chain forming a Ge—Ge bond or a group selected from a hydrogen atom, a halogen atom, a hydroxy group, and a substituted or unsubstituted aliphatic hydrocarbon group and alicyclic hydrocarbon group; and
a, b, c, and d are independently an integer including 0 and satisfy a+b++c≧1).

10. A pattern-formed coating film comprising a high refractive-index crystal alone that has a refractive index at a wavelength of 633 nm of 2.3 or more and 4.0 or less and that contains a Ge—Ge bond as a main component.

11. A pattern-formed coating film comprising:
within the same face:
a high refractive-index region having a refractive index at a wavelength of 633 nm of 2.3 or more and 4.0 or less and containing a Ge—Ge bond as a main component; and
a relatively low refractive-index region having a refractive index at a wavelength of 633 nm of 1.4 or more and 1.8 or less and containing a Ge—O—Ge bond as a main component, wherein a refractive index difference between the regions is 0.5 to 2.0.

12. The pattern-formed coating film according to claim 10, comprising:
producing a coating film containing a germanium compound of Formula [1] or Formula [2] containing a Ge—Ge bond as a backbone thereof;
irradiating the coating film with a radiation for transferring a pattern; and
baking the coating film under vacuum or in an inert gas atmosphere.

13. A production method of the pattern-formed coating film as claimed in claim 10, comprising:
producing a coating film containing a germanium compound of Formula [1] or Formula [2] containing a Ge—Ge bond as a backbone thereof;
irradiating the coating film with a radiation for transferring a pattern; and
baking the coating film under vacuum or in an inert gas atmosphere at a temperature of 400° C. or more.

14. A production method of the coating film as claimed in claim 11, comprising:
producing a coating film containing a germanium compound of Formula [1] or Formula [2] containing a Ge—Ge bond as a backbone thereof;
irradiating the coating film with a radiation for transferring a pattern; and
baking the coating film under vacuum or in an inert gas atmosphere at a temperature less than 400° C.
